(19) United States
(12) Patent Application Publication
(10) Pub. No.: US 2012/0030332 A1
(43) Pub. Date: Feb. 2, 2012

(54) MANAGEMENT SERVER, INFORMATION PROCESSING DEVICE AND COMPUTER-READABLE MEDIUM

(75) Inventors: Wataru Fukushima, Kahoku-shi (JP); Takuma Iryo, Kahoku-shi (JP); Tatsuya Komano, Kahoku-shi (JP); Masatoshi Yamamoto, Kahoku-shi (JP)

(73) Assignee: PFU LIMITED, Kahoku-shi (JP)

(21) Appl. No.: 13/192,260

(22) Filed: Jul. 27, 2011

(30) Foreign Application Priority Data
Jul. 28, 2010 (JP) 2010-168816

(51) Int. Cl. G06F 15/173

(52) U.S. Cl. 709/223

(57) ABSTRACT

A management server 30 connected to a network of which a connection to a management target device 20 from the management server 30 is cut off, includes an instruction accumulating unit 41 to accumulate an instruction with respect to the management target device 20, a connection accepting unit 42 to accept the connection from the management target device 20, and an instruction transmitting unit 43 to make the management target device acquire the instruction by transmitting via the connection the instruction accumulated by the instruction accumulating unit 41.

### CROSS-REFERENCE TO RELATED APPLICATION

This application is based upon and claims the benefit of priority of the prior Japanese Patent Application No. JP2010-168816, filed on Jul. 28, 2010, the entire contents of which are incorporated herein by reference.

### FIELD

This disclosure relates to a technology for managing a computer.

### BACKGROUND

A method and a system for instructing and controlling a device in a plurality of devices via a network are exemplified by a method and a system that include a stage of connecting a first device to the network, a stage at which a second device is connected to the network and specifies application interface descriptive data in a structural format for instructing and controlling the second device by another network device, a stage of providing the application interface descriptive data to the first device via the network and a stage of transferring control data and instruction data to the second device from the first device via the network by use of the application interface descriptive data in order to control an operation of the second device (refer to Japanese Unexamined Patent Publication No. 2002-514798).

Further, there is a communication method by which a network peripheral device connected to the network via a router obtains a remote service instruction over the network (refer to Japanese Patent Application Laid-Open Publication No. H10-164182). For others, there is a network information collecting system (refer to Japanese Patent Application Laid-Open Publication No. 2006-246195) in which a network information collecting device for collecting network information passing through a monitoring point on the network is configured separately from an information analyzing device for analyzing the network information collected by the network information collecting device. And there is a technology (refer to Japanese Patent Application Laid-Open Publication No. 2000-59871) by which each of devices functions as if an Internet server by use of HTTP (HyperText Transfer Protocol) as a substitute for a plurality of system unique protocols in communications between plural remote devices, and each individual user is provided with a user interface based on the unique function.

There has hitherto been utilized a network in which connections for communications are not transparent to each other such as a network enabling the communications with an external network by employing an address translation technique like NAT (Network Address Translation) and a network protected by a security technology such as a firewall. A good number of these networks are utilized at the present because of enabling unnecessary connections from the outside to be cut off and because of advantages in security being recognized.

In the mutually-opaque network such as this, in principle, a connection from the outside is cut off unless it is explicitly allowed, and hence the device connected to the inside of the network has a difficulty of being remote-controlled from the outside. Therefore, for maintaining the device connected to the inside of the network, a person in charge of maintenance needs to go to an actual place where the device is installed and perform a necessary operation for a management target device.

### SUMMARY

One aspect of the disclosure provides a management server including: an instruction accumulating unit for accumulating an instruction given to a management target device; a connection accepting unit for accepting a connection from the management target device; and an instruction transmitting unit for making the management target device acquire the instruction by transmitting via the connection the instruction accumulated by the instruction accumulating unit.

Further, this disclosure can be grasped as an information processing device as a management target managed by the management server described above. To be specific, one aspect of this disclosure is an information processing device of a management target, including: a connecting unit for establishing a connection with a management server which accumulates the instructions with respect to the information processing device; an instruction acquiring unit for acquiring the instruction with respect to the information processing device by receiving the instruction transmitted from the management server via the connection; and an instruction executing unit for controlling the information processing device by executing control based on the received instruction.

Yet further, this disclosure can be grasped as a method or a program executed by a computer. Moreover, one aspect of this disclosure may also be a non-transitory recording medium recorded with such a program that can be read by the computer and other devices, machines, etc. Herein, the recording medium readable by the computer and other devices, machines, etc connotes a recording medium capable of storing information such as data, programs, etc. electrically, magnetically, optically, mechanically or by chemical action, which can be read from the computer and so on.

### BRIEF DESCRIPTION OF THE DRAWINGS

FIG. 1 is a diagram illustrating an architecture of a device management system according to an embodiment.

FIG. 2 is a diagram illustrating functional configurations of a management target device and a management server according to the embodiment.

FIG. 3 is a flowchart illustrating a flow of an instruction accumulation process according to the embodiment.

FIG. 4 is a diagram illustrating a structure of an instruction table according to the embodiment.

FIG. 5 is a flowchart illustrating a flow of a management target control process according to the embodiment.

FIG. 6 is a flowchart illustrating a flow of an instruction accumulating process according to the embodiment.

FIG. 7 is a flowchart illustrating a flow of the management target control process according to the embodiment.

### DESCRIPTION OF EMBODIMENTS

An embodiment will hereinafter be described with reference to the drawings. The embodiment, which will hereinafter be discussed, exemplifies one example of carrying out the present invention but does not limit the present invention to a specific configuration that will hereinafter be described. It is preferable that the specific configuration corresponding to an embodiment is properly adopted.

### <System Architecture>

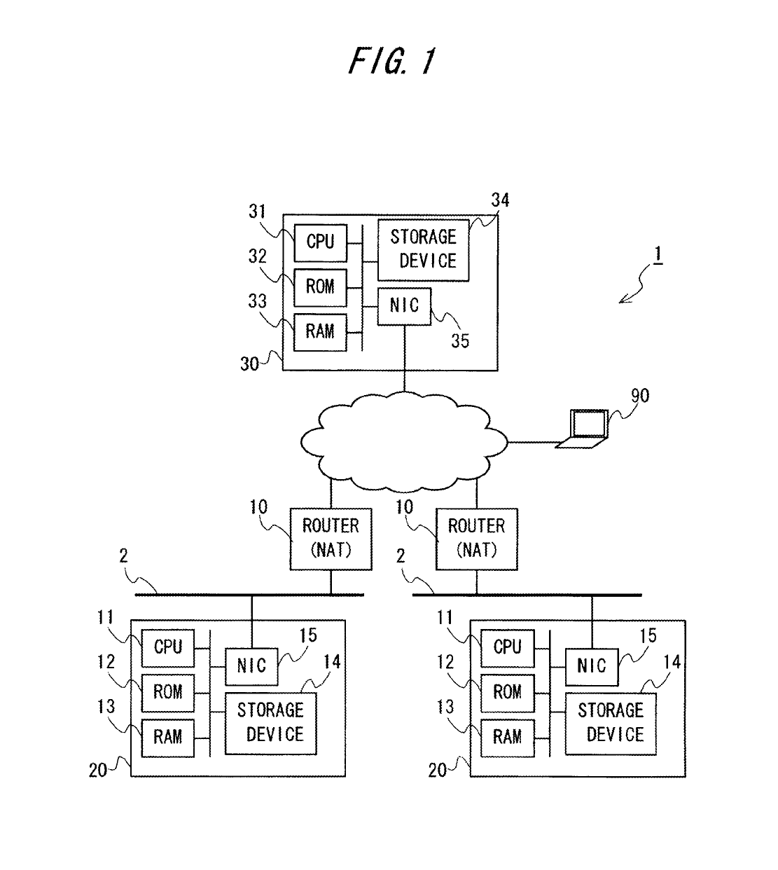

FIG. 1 is schematic diagram illustrating an architecture of a device management system 1 according to the embodiment. The device management system 1 according to the embodiment is a system configured on a plurality of network segments 2 (which will hereinafter be also referred to as [internal networks]) and an external network (which is, e.g., the Internet), and includes management target devices 20 which are connected to the network segments 2 to become target devices for management, and a management server 30 which manages the management target devices 20 on the plurality of network segments 2. Further, communications between the network segments 2 and the external network are relayed by routers 10 which provide the devices within the network segments 2 with a NAT (Network Address Translation) function and a firewall, and the router 10 cuts off a connection (access) to the network segment 2 from the external network. Therefore, the management target device 20 on the network segment 2 succeeds in establishing a connection with the management server 30 on the external network, however, the management server 30 on the external network has a difficulty to establish the connection with the management target device 20.

The management server 30 is a computer equipped with a CPU (Central Processing Unit) 31, a RAM (Random Access Memory) 33, a ROM (Read Only Memory) 32, a storage device 34 such as an EEPROM (Electrically Erasable and Programmable Read Only Memory) and a HDD (Hard Disk Drive), a communication unit such as a NIC (Network Interface Card.) 35 and so on. It should be noted that in the device management system 1 according to the embodiment, the management. server 30 is connected at a remote place via the Internet and a wide area network (WAN) and is provided by, e.g., ASP (Application Service Provider) but does not need being necessarily connected at the remote place.

Further, the management target device 20 is a computer equipped with a CPU (Central Processing Unit) 11, a RAM (Random Access Memory) 13, a ROM (Read Only Memory) 12, a storage device 14 such as an EEPROM (Electrically Erasable and Programmable Read Only Memory) and a HDD (Hard Disk Drive), a communication unit such as a NIC (Network Interface Card) 15 and so on.

Note that the management target device 20 may also be a communication cut-off device having a function of cutting off the communications of other devices within the network segment to which the management target device 20 is connected. The management target device 20, if defined as the communication cut-off device, notifies a predetermined target node connected to the network segment 2 of a MAC (Media Access Control) address of the management target device 20 as the MAC address associated with an IP (Internet Protocol) address of the router 10, then guides the communication (packet; datagram) with the external network from the target node to the management target device 20 and discards the thus-guided packet without forwarding this packet, thereby cutting off the communication of the target node. The management target device 20 may be, without being limited to the communication cut-off device, any type of device connected to the network segment 2. For example, the management target device 20 may be a device such as a personal computer, a server, a network printer and a network scanner, which are connected to the network segment 2.

The router 10 has the NAT function of translating a local IP address of the device connected to the network segment 2 into a communication-enabled address (e.g., a global IP address) in the external network. Owing to the NAT function provided by the router 10, the device connected to the internal network succeeds in establishing the connection with the external network. Further, the router 10 properly relays also the communication coming from the external network via the thus-established connection. The router 10 neither, however, relays the connection (communication) with the device connected to the internal network that is initiated from the device (e.g., the management server 30) on the external network nor translates the address, and hence it is difficult to establish the connection to the internal network from the external network.

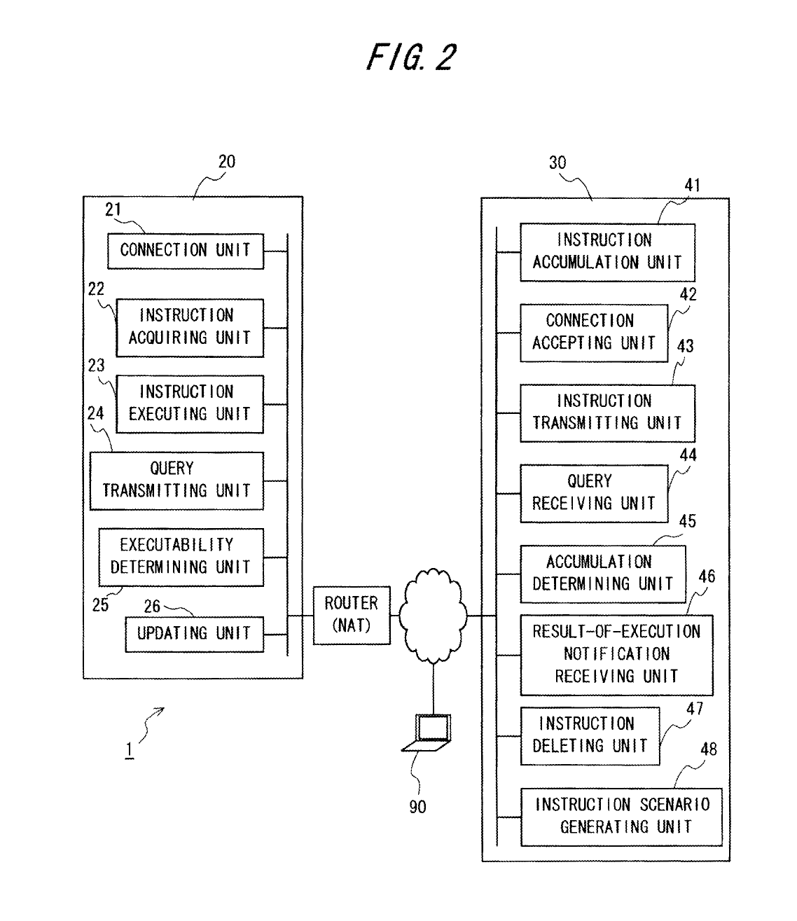

FIG. 2 is a diagram illustrating outlines of functional configurations of the management target device 20 and the management server 30 according to the embodiment. An instruction acquisition program recorded in the storage device 14 is read into the RAM 13 and executed by the CPU 11, whereby the management target device 20 functions as an information processing device including a connection unit (program module) 21, an instruction acquiring unit (module) 22, an instruction executing unit (module) 23, a query transmitting unit (module) 24, an executability determining unit (module) 25 and an updating unit (module) 26. Note that the respective functions incorporated into the management target device 20 are executed by the CPU 11 defined as the general-purpose processor in the embodiment, however, a part or the whole of these functions may also be executed by one single or a plurality of dedicated processors.

A management program recorded in the storage device 34 is read into the RAM 33 and executed by the CPU 31, whereby the management server 30 functions as a server including an instruction accumulating unit (module) 41, a connection accepting unit (module) 42, an instruction transmitting unit (module) 43, a query receiving unit (module) 44, an accumulation determining unit (module) 45, a result-of-execution notification receiving unit (module) 46, an instruction deleting unit (module) 47 and an instruction scenario generating unit (module) 48. Note that the respective functions incorporated into the management server 30 are executed by the CPU 31 defined as the general-purpose processor in the embodiment, however, a part or the whole of these functions may also be executed by one single or a plurality of dedicated processors.

### <Processing Flow>

Next, a flow of processes executed in the embodiment will hereinafter be described with reference to a flowchart. It is to be noted that in the processes which will be explained as below, the communications are performed among the management target device 20, the management server 30 and the user terminal 90, however, there is not a limit to a communication protocol to be adopted. For instance, the communication protocol may involve adopting HTTP (HyperText Transfer Protocol).

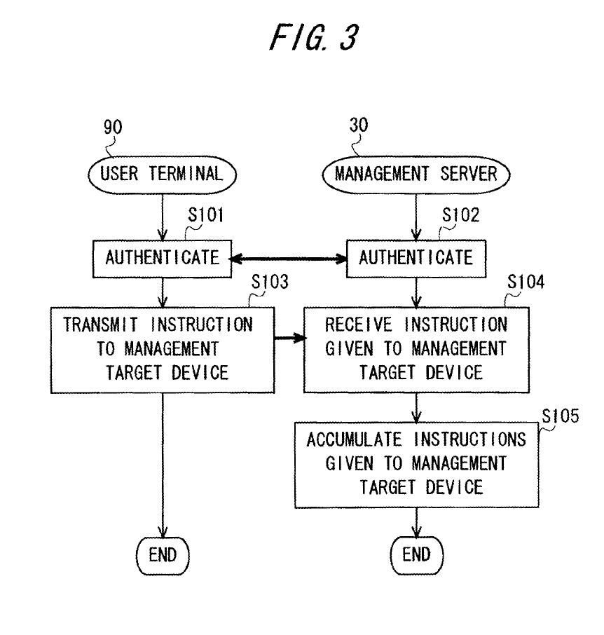

FIG. 3 is a flowchart illustrating a flow of an instruction accumulating process according to the embodiment. A start of the instruction accumulating process according to the embodiment: is triggered by such an event that an instruction (control command) to the management target device 20 is inputted from on the user terminal 90 in the device management system 1 described above and that a preset date/time of the instruction given to the management target device 20 is reached. Note that a specific content and a specific processing sequence of the process given in the flowchart are each one example for carrying out the present invention. The specific content and the specific processing sequence of the process given in the flowchart may be properly selected corresponding to an embodiment.

In step S101 and step S102, the user terminal 90 and the management server 30 authenticate each other. The user terminal 90 transmits information for authentication to the management server 30 and undergoes the authentication by the management server 30 (step S101). Similarly, the management server 30 transmits the information for authentication to the user terminal 90 and undergoes the authentication by the user terminal 90 (step S102). Thus, the user terminal 90 can determine whether or not the communication partner management server 30 is a communication partner device to which the instruction given to the management target device 20 may be transferred. Further, the management server 30 can determine whether or not the communication partner user terminal 90 is a user terminal 90 having authority to give the instruction to the management target device 20. The authentication may, however, be omitted, and, if the authentication is conducted also, only any one of the authentications may be executed, i.e., the user terminal 90 authenticates the management server 30, or alternatively the management server 30 authenticates the user terminal 90. Moreover, if authenticated mutually, the authentication sequence is not limited. When the user terminal 90 and the management server 30 complete the mutual authentications, the processing proceeds to step S103.

In step S103 and step S104, the instruction with respect to the management target device 20 is transmitted and received. The user terminal 90 transmits, to the management server 30, the instruction with respect to the management target device 20 (step S103). The network architecture according to the embodiment is that the user terminal 90 is connected to the external network via the network segment subordinate to the router which provides the NAT function and the firewall. Therefore, the user terminal 90 is disabled from transmitting the instruction directly to the management target device 20 by establishing the connection with the management target device 20 connected to the network segment subordinate to the router. Consequently, in the embodiment, the user terminal 90 transmits the instruction with respect to the management target device 20 to the management server 30.

In step S103, the packet transmitted to the management server 30 from the user terminal 90 contains a user ID, a management target device ID and the instruction. Herein, the user ID is defined as information from which the user or the user terminal 90 authenticated in the processes in step S101 and step S102 can be identified. Further, the management target device ID is the information enabling the management target device 20 to be identified, and may involve using, e.g., the MAC address or a manufacture serial number of the management target device 20. Moreover, in the case of transmitting and receiving a plurality of instructions with respect to the same management target device 20, the packet transmitted to the management server 30 from the user terminal 90 may further contain information which represents an instruction execution sequence with respect to the management target device 20.

The instruction given to the management target device 20 is exemplified by an initializing (reset) instruction, a setting instruction, a stop instruction, a shutdown (termination) instruction, a restart instruction and a maintenance information extracting instruction of the management target device 20. Further, an instruction for executing a special function incorporated into the management target device 20 may be enabled. For example, if the management target device 20 is the communication cut-off device, an instruction for executing a function of cutting off the communications of other devices within the network segment to which the management target device 20 is connected, may also be enabled. The instruction may be specified by using a value allocated for identifying a content of the instruction, may be specified by employing a flag set in a field for identifying the content of the instruction, and may further be specified by test data indicating the content of the instruction. For instance, what can be adopted as a format of the instruction is XML (Extensible Markup Language), HTML (HyperText Markup Language), etc. The management server 30 receives the instruction, transmitted by the user terminal 90, with respect to the management target device 20 (step S104). Upon completing the transmission and reception of the instruction, the processing proceeds to step S105.

In step S105, the instructions given to the management target device 20 are accumulated. The instruction accumulating unit 41 of the management server accumulates the instructions given to the management target device 20, which are received from the user terminals 90 in step S104, in an instruction table configured on the storage device 34 of the management server 30 in the way of being associated with the user IDs and the management target device IDs received similarly in step 104. The instruction table may be, however, configured in a database etc that is connectable from the management server 30 as a substitute for the storage device 34 of the management server 30. Moreover, in the case of receiving the plurality of instructions given to the same management target device 20, the information for specifying the execution sequence of the instructions with respect to the management target device 20 is further accumulated.

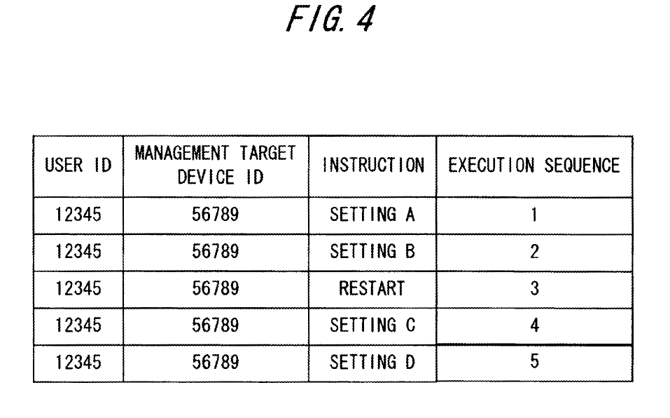

FIG. 4 is a diagram illustrating a structure of the instruction table according to the embodiment. The instruction table is accumulated with the instructions given to the management target device 20, which are received from the user terminals 90 in the way of being associated with the user IDs, the management target device IDs and the execution sequence, thereby enabling the proper management target device 20 to acquire the instructions in the adequate sequence when establishing the connection from the management target device 20 in a management target control process that will be described later on. When the received instructions are accumulated in the instruction table, the processes given in the flowchart of FIG. 3 are finished.

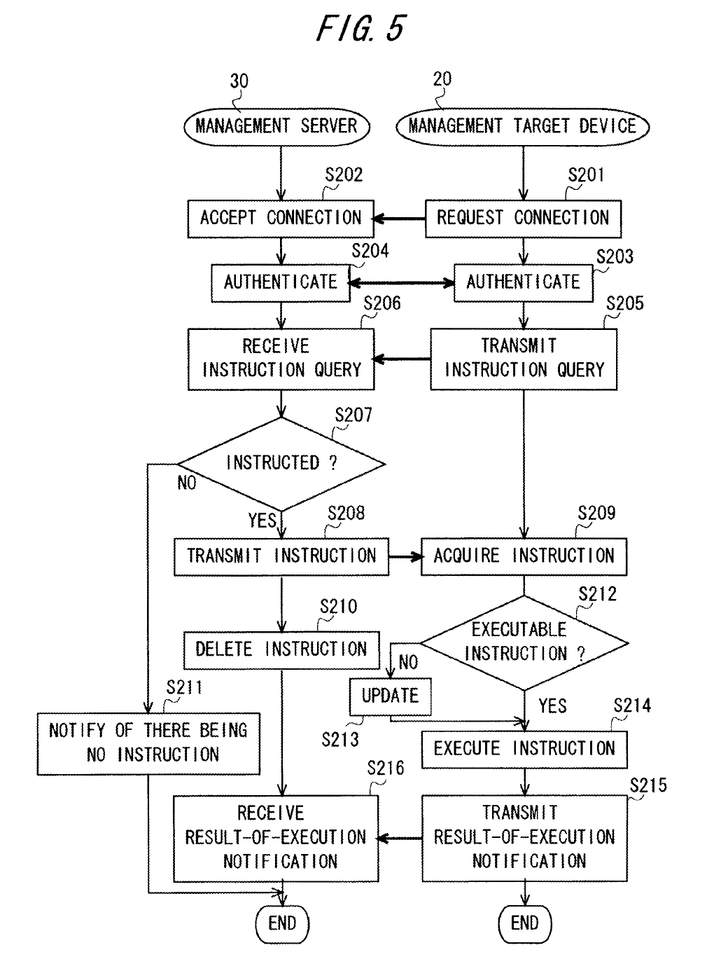

FIG. 5 is a flowchart illustrating a flow of the management target control process according to the embodiment, The management target control process according to the embodiment is executed periodically (e.g., at 1-minute intervals) by the management target device 20. Further, the management target control process may also be executed at a predetermined timing (e.g. a timing when completing the restart of the management target device 20). Note that a specific content and a specific processing sequence of the process given in the flowchart are each one example for carrying out the present invention. The specific content and the specific processing sequence of the process given in the flowchart may be properly selected corresponding to an embodiment.

In step S201 and step S202, the connection between the management target device 20 and the management server 30 is established in response to a request sent from the management target device 20. The connection unit 21 of the management target device 20 transmits the connection request to the management server 30 (step S201), and the connection accepting unit 42 of the management server 30 accepts the connection request transmitted from the management target device 20 (step S202), thereby establishing the connection between the management target device 20 and the management server 30. For example, TCP/IP (Transmission Control Protocol/Internet Protocol) is utilized as the communication protocol, in which case a TCP (Transmission Control Protocol) connection between the management target device 20 and the management server 30 is established by initiating, from the side of the management target device 20, the establishment of a TCP connection based on a so-called TCP 3-way handshake. In the case of establishing the connection based on the TCP 3-way handshake, the TCP connection is established by transmitting a SYN (SYNchronization) packet (corresponding to a connection request) to the management server 30 from the management target device 20, transmitting a SYN/ACK (ACKnowledgment) packet to the management target device 20 from the management server 30 receiving the SYN packet and transmitting an ACK packet to the management server 30 from the management target device 20 receiving the SYN/ACK packet. Note that the flowchart depicted in FIG. 5 omits an illustration of the detailed transmission/reception of the packets based on the 3-way handshake. As for the establishment of the connection, however, the communications are performed across the address translation (NAT) and the firewall, and hence the communication (the transmission of the SYN packet in the case of TCP) for establishing the connection may be initiated from the management target device 20, in which the specifically-adopted connection is not limited to the TCP connection. Thereafter, the processing proceeds to step S203.

In step S203 and step S204, the management target device 20 and the management server 30 authenticate each other. The management target device 20 transmits the information for authentication to the management server 30 and undergoes the authentication by the management server (step S203). Similarly, the management server 30 transmits the information for authentication to the management target device 20 and undergoes the authentication by the management target device 20 (step S204). Thus, the management target device 20 can determine whether or not the communication partner management server 30 is a communication partner device which may acquire the instruction (in other words, the management target device 20 confirms that the communication partner device is not the management server 30 counterfeited to get a malicious instruction acquired). Further, the management server 30 can determine whether or not the communication partner management target device 20 is a management target device to which the instruction may be given. The authentication may, however, be omitted, and, if the authentication is conducted also, only any one of the authentications may be executed, i.e., the management target device 20 authenticates the management server 30, or alternatively the management server 30 authenticates the management target device 20. Moreover, if authenticated mutually, the authentication sequence is not limited. When the management target device 20 and the management server complete the mutual authentications, the processing proceeds to step S205.

In step S205 through step 207, the instruction query is transmitted and received, and it is determined whether there is the instruction given to the management target device 20 or not. The query transmitting unit 24 of the management target device 20 queries the management server 30 about whether or not there is a not-yet-acquired instruction to the self-device (the management target device 20 which transmits the instruction query) via the connection established in the processes of step S201 and step S202 (step S205). The query receiving unit 44 of the management server 30 receives the instruction query from the management target device 20 via the established connection (step S206). Then, the accumulation determining unit 45 searches through the instruction table by use of the device ID of the management target device 20 defined as the instruction query sender, thereby determining whether or not the not-yet-acquired instruction associated with the management target device ID is accumulated in the instruction table (step S207). If accumulated with the instruction given to the management target device 20 as the instruction query sender, the processing advances to step S208. Whereas if not accumulated with the instruction given to the management target device 20 as the instruction query sender, the processing diverts to step S211.

Note that the establishment of the connection and the authentication explained in steps S201 through S204 are not required to be conducted each time polling from the management target device 20 to the management server 30 is done based on the execution of the present flowchart. When the connection is once established and the authentication is completed, the management target device 20 can use the already-established connection in the periodic polling till the connection is disconnected or till a valid period of the authentication elapses (expires). Namely, the management target device 20 can start the process from step S205 while omitting the processes in steps S201 through S204 till the once-established connection is disconnected or till the valid period of the authentication elapses.

In step S211, a notification saying that there is no instruction is transmitted to the management target device 20. The management server 30 transmits a notification, saying that the instruction to the management target device 20 is not accumulated, to the management target device 20 as the sender of the instruction query received in step S206. Thereafter, the management target device 20 receives the notification (its illustration is not omitted) transmitted by the management server 30, and the processes shown in this flowchart are finished.

In steps S208 through S210, the instruction is transmitted and received, and the transmitted instruction is then deleted. The instruction transmitting unit 43 of the management server 30, when determining in step S207 that there is accumulated the instruction to the management target device 20, transmits the instruction retrieved in the searching process to the management target device 20 as the sender of the instruction query received in step S206 (step S208). Note that if the plurality of instructions is retrieved, the retrieved instructions may be transmitted on a one-by-one basis in the execution sequence from the earliest down to the latest and may also be transmitted simultaneously in a way that allocates the execution sequence thereto. The processes shown in this flowchart are, as described above, executed periodically (e.g., at the 1-minute intervals), and therefore the not-transmitted instructions are sequentially transmitted corresponding to the instruction queries from the next time onward according to the execution sequence. The instruction transmitted by the management server 30 is received by the instruction acquiring unit 22 of the management target device 20 via the established connection (step S209). Further, the instruction deleting unit 47 of the management server 30, when the instruction is transmitted, deletes the already-transmitted instruction from the instruction table (step S210). Thereafter, the processing proceeds to step S212.

In steps S212 through S214, it is determined whether the received instruction is an executable instruction or not, and, if executable, the instruction is to be executed. Whereas if the received instruction is not the executable instruction, the management target device 20 is updated into an instruction-executable status and thereafter executes the instruction. The executability determining unit 25 of the management target device 20 compares the received instruction with a pre-retained list of the instructions executable by the self-device (the management target device 20 receiving the instruction), and determines whether the received instruction is executable in the present status or not (step S212). If the received instruction exists in the executable instruction list, i.e., if the received instruction is executable, the instruction executing unit 23 of the management target device 20 reads the program necessary for executing the instruction from the storage device 14 etc and gets the CPU 11 to execute this instruction, thus implementing the instruction (step S214).

Whereas if the received instruction does not exist in the executable instruction list, i.e., if the received instruction is unexecutable, the updating unit 26 of the management target device 20 updates an environment for executing the instruction in the management target device 20 into a received-instruction executable status by a method such as downloading an update program for update and an additional module in a manner that connects with a server (of which an illustration is omitted) for update (step S213). The instruction executing unit 23 of management target device 20 executes, after a completion of updating, the received instruction (step S214). The acquired instruction is executed, and thereafter the processing proceeds to step S215.

Incidentally, there is a possibility that the update of the management target device 20 involves restarting the device and reconfiguring the system. Hence, on the occasion of the update, if necessary, the instruction received in step S209 may be saved into the nonvolatile storage device 14 from the volatile RAM 13 or alternatively may be reacquired from the management server 30 after completing the update. The instruction can be reacquired by iterating the processes from step S201 (the processes from step S205 if the connection is not disconnected). In the case of adopting the reacquisition of the instruction, however, the management server 30 needs to retain the not-yet-executed instruction in the management target device 20 without deleting this instruction. Hence, in the case of adopting the reacquisition of the instruction, it is preferable for the management server 30 not to delete the instruction from the instruction table (i.e., the instruction is not deleted in step S210) till receiving a result-of-execution notification, which notifies that the execution of the instruction is completed, from the management target device 20.

In steps S215 and S216, the result-of-execution notification is transmitted and received. The management target device 20, upon completing the execution of the instruction in step S214, accumulates the result-of-execution notification in the storage device 14, and further transmits the result-of-execution notification for notifying the result of the execution of the acquired instruction to the management server 30 (step S215). This result-of-execution notification contains at least the information (the management target device ID etc) enabling the management target device 20 to be identified, the information for specifying the executed instruction and the result of execution (completion, failure, etc). The management server 30, when the result-of-execution notification receiving unit 46 receives the result-of-execution notification (step S216), accumulates the result-of-execution notification by a method such as outputting the notification to a log file. Thereafter, the processes shown in this flowchart are finished.

An administrator may also be notified of the result of the execution of the instruction. Further, the management server 30 may notify the administrator of the execution result, and the management target device 20 may also notify. For example, if the result-of-execution notification target device is connected to the network segment 2, because of the NAT function and the firewall being incorporated as described above, the management server 30 can not notify of the execution result. The system according to the embodiment, even in such a case, enables the execution result to be notified to the device disabled from being notified of the execution result from the management server 30 by notifying of the execution result from the management target device 20. For instance, such a result-of-execution notification method can be adopted that the IP address of the result-of-execution notification target device is registered in the management server 30, then, if the registered TP address is a global IP address of the router 10 (i.e., the IP address of the notification target device undergoes the address translation because of the notification target device being connected to the network segment 2), the management target device 20 notifies of the execution result, but, whereas if the registered IP address is not the global IP address of the router 10, the management server 30 notifies of the execution result. Further, if the actual IP address (i.e., the IP address not undergoing the address translation) of the result-of-execution notification target device is registered in the management server 30, the management server 30 determines whether the registered IP address is a private IP address or not, then, in the case of the private IP address, determines that the notification target device is connected to the network segment 2, and may get the management target device 20 to notify of the execution result.

Note that the discussion based on this flowchart has dealt with the case of adopting the protocol such as TCP for previously establishing the connection before transmitting and receiving the instruction query packet and the instruction packet. Depending on another embodiment, however, such a communication system may be adopted that the connection from the management target device 20 (such as transmitting the instruction query packet) is conducted without establishing the connection beforehand. In this case, the processes from step S201 through step S204 are omitted, the process may be started from step S205.

According to the processes shown in the flowchart, the management target device 20 is made to acquire the instruction by itself via the connection initiated from the management target device 20, whereby the management target device 20 can be preferably controlled also in such an environment that the management server 30 is connected to the network in which to cut off the connection to the management target device 20 from the management server 30.

### <Variation of Process>

In the flowchart described above, in principle, there is adopted the method of acquiring on the one-by-one basis the instructions accumulated in the instruction table in accordance with the execution sequence or the method of acquiring the instructions batchwise by showing the execution sequence. In place of these instruction issuing methods, however, an instruction scenario is generated corresponding to contents of the plurality of instructions, and the management target device 20 is made to acquire the instructions according to the thus-generated instruction scenario, and the management server 30 may be thereby enabled to control in detail the instruction execution state in the management target device 20.

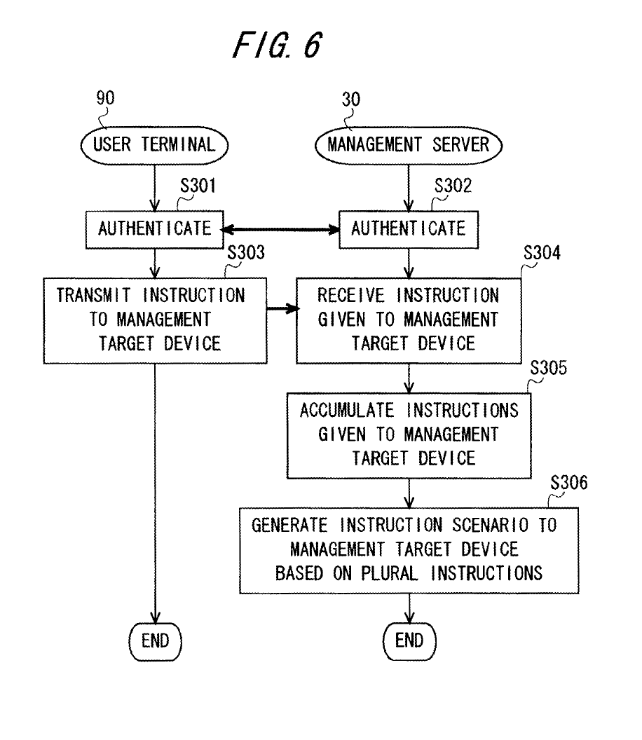

FIG. 6 is a flowchart illustrating a flow of an instruction accumulation process according to the embodiment. A start of the instruction accumulation process according to the embodiment is triggered by such an event that the instruction to the management target device 20 is inputted from on the user terminal 90 in the device management system 1 described above and that the preset date/time of the instruction given to the management target device 20 is reached. Note that a specific content and a specific processing sequence of the process given in the flowchart are each one example for carrying out the present invention. The specific content and the specific processing sequence of the process given in the flowchart may be properly selected corresponding to an embodiment.

Processes from step S301 through step S305 are substantially the same as the processes from step S101 through step S105, which have been described by using FIG. 3, and hence the explanations thereof are omitted.

In step S306, the instruction scenario to the management target device 20 is generated based on the plurality of instructions. The instruction scenario generating unit 48 of the management server 30, when receiving the plurality of instructions given to the same management target device 20 from the user terminal 90 or when the instructions to the same management target device 20 are accumulated in the instruction table, generates the instruction scenario consisting of the plural instructions to the management target device 20.

The instruction scenario is a scenario generated in a way that takes into consideration a processing flow on the occasion of executing the instruction in the management target device 20 as well as being generated on the occasion of giving the instruction to the management target device 20. The instruction scenario generated in the embodiment contains at least any one of items of information shown below. The instruction scenario may, however, contain information other than the information exemplified as below in order to specify the scenario on the occasion of giving the instruction to the management target device 20. When the instruction scenario is generated, the processes shown in this flowchart are terminated.

(1) A sequence of making the management target device 20 execute the instruction;
(2) A combination of one or plural instructions acquired through the transmission conducted one time;
(3) Timing of getting the instruction acquired; and
(4) A change of instruction corresponding to the execution result of the instruction in the management target device 20.

### (1) A Sequence of Making the Management Target Device 20 Execute the Instruction

The instruction scenario generating unit 48, if the plurality of instructions is accumulated, generates the instruction scenario with the execution sequence allocated to the plurality of instructions by referring to a pre-retained scenario generation guideline etc. For instance, the instruction scenario generating unit 48, if a purport that the restart is recommended after the predetermined setting has been done is set in the guideline, adds a restart instruction and specifies the execution sequence so as to execute, when a predetermined setting instruction is uploaded from the user terminal, the restart instruction after the predetermined instruction.

(2) A Combination of One or Plural Instructions Acquired through the Transmission Conducted One Time

The instruction scenario generating unit 48 divides the plurality of instructions acquired for the management target device 20 into units each containing one or plural instructions, and generates the instruction scenario for getting the management target device 20 to acquire the instructions on a unit-by-unit basis For example, the instruction scenario generating unit 48, if there are a series of instructions (setting A→setting B→restart→setting C→setting D) with the restart being interposed therebetween, generates the instruction scenario of transferring the instructions and the restart instruction inclusive (setting A→setting B→restart) as a unit 1, and, when the instruction query is again received after completing the restart of the management target device 20, transferring the instructions that should be executed after completing the restart as a unit 2 (setting C→setting D).

### (3) Timing of Getting Instruction Acquired

The instruction scenario generating unit 48 generates the instruction scenario in which the proper acquisition timing corresponding to the instruction is set on the per instruction basis. For instance, the instruction scenario generating unit 48 generates, if accumulated with the instruction requiring a fixed or longer period of time for processing, the instruction scenario of not transferring, after transferring this instruction, the next instruction even when the instruction query is made.

### (4) A Change of Instruction Corresponding to the Execution Result of the Instruction in the Management Target Device 20

The instruction scenario generating unit 48 generates the instruction scenario enabling a change of instruction acquired by the management target device 20 on the occasion of the next instruction query corresponding to the contents (normal completion, failure, etc) of the result-of-execution notification received in step S416 that will be described later on and other states (timeout because of riot receiving the result-of-execution notification, etc). For example, the instruction scenario generating unit 48 generates the instruction scenario of changing, in the case of receiving the result-of-execution notification implying a failure in execution and in the case of not receiving the execution result for a predetermined or longer period of time, the scenario to an abnormal-time scenario different from the case in which the scenario advances normally, and enabling the management target device 20 to acquire the restart instruction on the occasion of the next instruction query.

Given next is a description of a processing flow in the case of executing a management target control process according to the instruction scenario generated in the processes explained by use of FIG. 6.

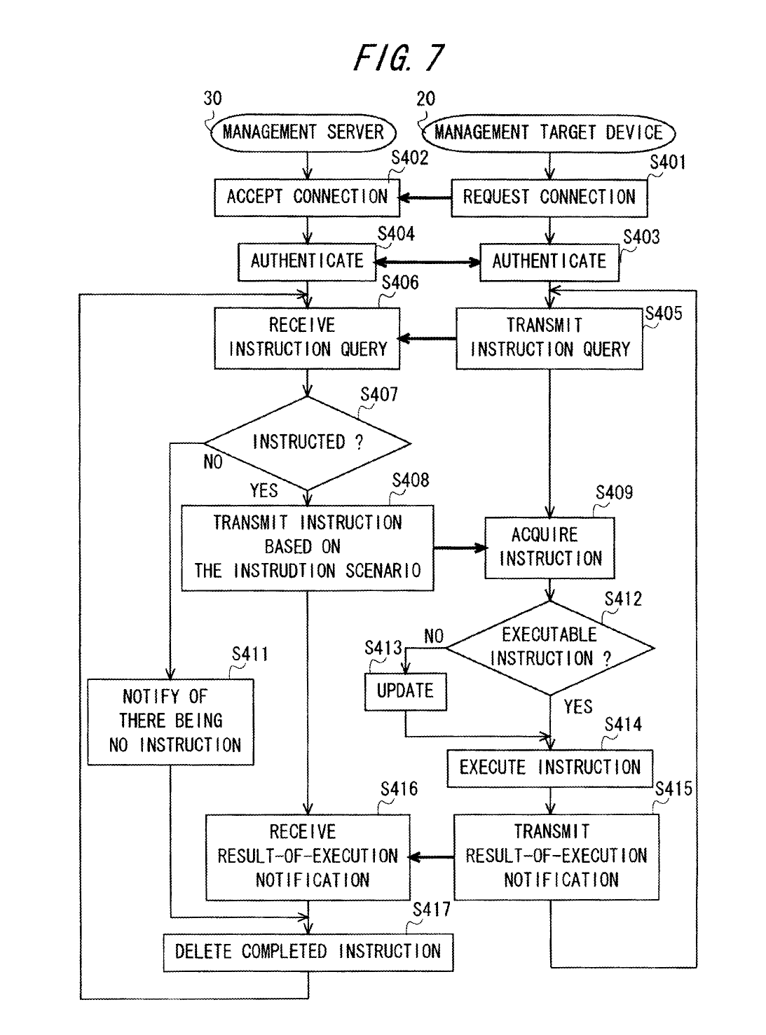

FIG. 7 is a flowchart illustrating a flow of the management target control process according to the embodiment. The management target control process according to the embodiment is periodically executed by the management target device 20. Further, the management target control process may be executed at the predetermined timing such as when completing the restart of the management target device 20. Note that a specific content and a specific processing sequence of the process given in the flowchart are each one example for carrying out the present invention. The specific content and the specific processing sequence of the process given in the flowchart may be properly selected corresponding to an embodiment.

Processes from step S401 through step S407 are substantially the same as the processes from step S201 through step S207, which have been described by using FIG. 5, and hence the explanations thereof are omitted.

In steps S408 and S409, the instruction is transmitted and received according to the instruction scenario. The instruction transmitting unit 43 of the management server 30 transmits, if it is determined in step S407 that the instruction to the management target device 20 is accumulated, the instruction to the management target device 20 in accordance with the instruction scenario retrieved in the searching process (step S408). Herein, the instruction is transmitted based on the instruction scenario generated in step S306 of FIG. 6 explained above, and hence the instruction transmitting unit 43 transmits the instruction that should be acquired next by the management target device 20 according to the items of information such as (1) A sequence of making the management target device 20 execute the instruction; (2) A combination of one or plural instructions acquired through the transmission conducted one time; (3) Timing of getting the instruction acquired; and (4) A change of instruction corresponding to the execution result of the instruction in the management target device 20, which are contained in the instruction scenario. The instruction transmitted by the management server 30 is received by the instruction acquiring unit 22 of the management target device 20 via the established connection (step S409). Thereafter, the processing proceeds to step S412.

In the processes shown in the flowchart, the management server 30 neither executes the process corresponding to step S210 in FIG. 5 nor deletes the instruction from the instruction table till receiving the result-of-execution notification from the management target device 20 (step S416). Therefore, according to the processes shown in the flowchart, even in such a case that the acquired instruction is lost without completing the execution of the acquired instruction due to some sort of cause, the not-yet-acquired instruction can be acquired from the management server 30 by repeating the processes again from step S401 (the processes from step S405 if the connection is not disconnected).

Processes from step S411 through step S416 are substantially the same as the processes from step S211 through step S216, which have been described by using FIG. 5, and hence the explanations thereof are omitted.

The completed instruction is deleted in step S417. The instruction deleting unit 47 of the management server 30, when receiving the result-of-execution notification in step S416, specifies the completed instruction and the management target device 20 related to this completed instruction by referring to the information enabling the management target device 20 to be identified and the information specifying the completed instruction, which are contained in the result-of-execution notification. Then, the instruction deleting unit 47 of the management server 30 deletes the record associated with the specified instruction from the instruction table. Thereafter, the processing proceeds to step S405.

Namely, in the processes shown in the flowchart, the processes from step S405 through step S417 are iterated, and in step S408 the instruction is transmitted based on the instruction scenario, whereby the management server 30 manages the control process of the management target device 20. Herein, the instruction transmitting unit 43 gets, after receiving the result-of-execution notification in step S416, the management target device 20 to acquire the instruction subsequent to the instruction related to the result-of-execution notification in terms of the instruction scenario (step S408). If the once-established connection (e.g., the TCP connection) is disconnected for the reason such as restarting the management target device 20, a new connection is established by repeating the processes again from step S401, and the instruction is transmitted based on the instruction scenario.

Note that the management target device 20 is controlled under so-called synchronous control of transmitting the instruction along the instruction scenario, while the management server 30 checks the result-of-execution notification in the embodiment. In place of the synchronous control such as this, however, asynchronous control may also be adopted. In the case of adopting the asynchronous control, the instruction transmitting unit 43 of the management server 30 makes the management target device 20 acquire at the preset timing the instruction accumulated by the instruction accumulating unit 41 irrespective of the contents of the result-of-execution notification.

The control based on the instruction scenario explained above can, however, incorporate the asynchronous control. To be specific, there is generated the instruction scenario containing the [(3) Timing of getting the instruction acquired] described above and set to execute the timing control regardless of the contents of the result-of-execution notification, and the control is done based on this instruction scenario, whereby a part or the whole of the control along the instruction scenario can be set as the asynchronous control.

According to the processes shown in the flowcharts of FIGS. 6 and 7, the instruction scenario is generated beforehand in the management server 30, and the management target device 20 is thereby made to acquire the instruction on the basis of the instruction scenario generated in a manner that takes account of the processing flow on the occasion of executing the instruction even in the case of giving the complicated instructions consisting of the plurality of instructions to the management target device 20, with the result that the management target device 20 can be controlled under the proper management.

What is claimed is:

1. A management server comprising:
an instruction accumulating unit for accumulating an instruction given to a management target device;
a connection accepting unit for accepting a connection from said management target device; and
an instruction transmitting unit for making said management target device acquire the instruction by transmitting via the connection the instruction accumulated by said instruction accumulating unit.

2. A management server according to claim 1, wherein said connection accepting unit accepts the connection from the management target device by establishing a connection between said management server and said management target device in response to a connection request transmitted from said management target device.

3. A management server according to claim 1, further comprising:
a query receiving unit for receiving via the connection a query about whether or not there is the instruction transmitted from the management target device and accumulated by said instruction accumulating unit; and
an accumulation determining unit for determining, if said query receiving unit receives the query, whether or not the instruction to said management target device as an inquirer is accumulated in said instruction accumulating unit,
wherein said instruction transmitting unit, if said accumulation determining unit determines that the instruction to said management target device is accumulated, makes said management target device acquire the accumulated instruction.

4. A management server according to claim 1, wherein said instruction accumulating unit accumulates the instruction received from a user terminal and given to said management target device.

5. A management server according to claim 1, further comprising:
a result-of-execution notification receiving unit for receiving a result-of-execution notification of the instruction. in said management target device; and
an instruction deleting unit for deleting the instruction related to the result-of-execution notification in the instructions accumulated in said instruction accumulating unit after receiving the result-of-execution notification.

6. A management server according to claim 1, further comprising:
a result-of-execution notification receiving unit for receiving a result-of-execution notification of the instruction in said management target device,
wherein said instruction transmitting unit makes said management target device acquire the instruction subsequent to the instruction related to the result-of-execution notification after receiving the result-of-execution notification.

7. A management server according to claim 1, wherein said instruction transmitting unit makes said management target device acquire at preset timing the instructions accumulated by said instruction accumulating unit.

8. A management server according to claim 1, further comprising:
an instruction scenario generating unit for generating an instruction scenario containing information specifying at least any one of a sequence of making said management target device execute the instruction on the basis of contents of the plurality of instructions to said management target device, a combination of one or plural instructions acquired through the transmission conducted one time, a timing of getting the instruction acquired and a change of the instruction corresponding to the execution result of the instruction in said management target device,
wherein said instruction transmitting unit makes said management target device acquire the instruction in accordance with the instruction scenario.

9. A management server according to claim 1, wherein said management server is connected to a network of which a connection to said management target device from said management server is cut off.

10. A non-transitory computer-readable medium recorded with a program for managing a management target device, to make a computer execute:
accumulating an instruction given to a management target device;
accepting a connection from said management target device; and
making said management target device acquire the instruction by transmitting via the connection the instruction accumulated in said accumulating.

11. An information processing device of a management target, comprising:
a connecting unit for establishing a connection with a management server which accumulates the instructions with respect to said information processing device;
an instruction acquiring unit for acquiring the instruction with respect to said information processing device by receiving the instruction transmitted from said management server via the connection; and
an instruction executing unit for controlling said information processing device by executing control based on the received instruction.

12. An information processing device according to claim 11, wherein said connecting unit establishes a connection between said information processing device and said management server by transmitting a connection request to said management server.

13. An information processing device according to claim 11, further comprising:
a query transmitting unit for transmitting a query about whether there is the accumulated instruction or not to said management server via the connection,
wherein said instruction acquiring unit acquires the instruction transmitted from said management server in response to the query.

14. An information processing device according to claim 11, further comprising:
an executability determining unit for determining whether the instruction acquired by said instruction acquiring unit is an executable instruction or not; and
an updating unit for updating, if the instruction is determined not to be the executable instruction, an environment for executing the instruction in said information processing device into an instruction executable status,
wherein said instruction executing unit, if said executability determining unit determines that the instruction is the executable instruction or if said updating unit completes updating, executes the control based on the received instruction.

15. An information processing device according to claim 11, wherein said information processing device is connected to a network of which a connection to said information processing device from said management server is cut off.

16. A non-transitory computer-readable medium recorded with a program for acquiring an instruction from a management server, to make a computer execute:
establishing a connection with a management server which accumulates the instructions with respect to said computer;
acquiring the instruction with respect to said computer by receiving the instruction transmitted from said management server via the connection; and
controlling said computer by executing control based on the received instruction.
